(19) United States
(12) Patent Application Publication
(10) Pub. No.: US 2008/0320500 A1
(43) Pub. Date: Dec. 25, 2008

(54) Remote human interface device in an aggregate computer system

(75) Inventors: Yang Li, Beijing (CN); Lifeng Wang, Beijing (CN); Jian Wang, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/821,663

(22) Filed: Jun. 25, 2007

(51) Int. Cl. G06F 3/038

(52) U.S. Cl. 719/324

(57) ABSTRACT

Described is a technology by which a human interface device (e.g., a keyboard or mouse) physically coupled to a first computing machine controls a second computing machine in an aggregated computer system. When the first computing machine enters a device producer state with respect to the human interface device, the first machine routes the human interface device data to the second computing machine. The second computing machine receives the human interface device data, and simulates a physical connection of the human interface device to the second computing machine by providing the human interface device data to a virtual device driver loaded on the second computing machine. The virtual device driver may be registered with a virtual bus driver to receive the data.

### CROSS-REFERENCE TO RELATED APPLICATION

The present application is related to the copending U.S. patent application entitled “Aggregate Personal Computer System,” assigned to the assignee of the present application, filed concurrently herewith and hereby incorporated by reference.

### BACKGROUND

Contemporary operating systems are primarily designed for personal computer use, which tends to create complexity when attempting to couple additional computing machines to the personal computer. For example, for many computer users it is a difficult task to establish a connection between the user's personal computer such as a laptop and the user's Smartphone (herein considered a computing machine with mobile telephone capability), even when the two computing machines both run operating systems from the same operating system vendor.

Further, consider a user working with locally networked computers. Even thought the computers are networked, they are disaggregated with respect to resource sharing. For example, each computer system has its own mouse and keyboard, and in general the user cannot seamlessly use the mouse and keyboard of one computer with another computer, (e.g., without manually changing the wired or wireless connections).

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a human interface device (e.g., a keyboard, a mouse, or other pointing device) physically coupled to a first computing machine controls a second computing machine. The first computing machine transmits the human interface device data over a communication means to the second computing machine. The second computing machine receives the human interface device data, and simulates a physical connection of the human interface device to the second computing machine by providing the human interface device data to a virtual driver loaded on the second computing machine.

In one aspect, a human interface device physically coupled by a wired or wireless connection to a first computing machine generates data. The first computing machine routes the human interface device data to a second computing machine via a remote communications means. A virtual human interface device driver of the second computing machine receives the data thereby controlling operation of the second computing machine from the human interface device. The virtual human interface device driver may register with a virtual bus driver to receive the data.

In one aspect, a first computing machine is configured as a human interface device producer that generates human interface device data from a corresponding human interface device physically coupled thereto. A second computing machine that is not physically coupled to the human interface device is configured as a human interface device consumer. A virtual driver on the second computing machine that corresponds to the human interface device receives the human interface device data from the first computing machine. In one example, an aggregate device manager of the first computing machine determines that the human interface device is in a device producer state, and as a result, sends the human interface device data to the second computing machine. The producer state continues until receiving information indicating that the human interface device is no longer in that state, in which the human interface device data are sent to an operating system of the first computing machine.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is an example block diagram representation of an aggregate computing system comprising interconnected computing machines.

FIG. 2 is a block diagram representation of example components of two interconnected computing machines that participate as part of an aggregate computing system to share mouse and keyboard devices.

FIG. 3 is a block diagram representation of mouse and keyboard data flow between two interconnected computing machines that participate as part of an aggregate computing system.

FIG. 4 is a flow diagram representing example steps that may be taken add a virtual device, including a human interface device, to an aggregate computer system.

FIG. 5 is a flow diagram representing example steps that may be taken when processing locally generated mouse and/or keyboard data for local or remote control of a computing machine.

FIG. 6 is a flow diagram representing example steps that may be taken when processing remotely generated mouse and/or keyboard data for remote control of a computing machine.

FIG. 7 shows an illustrative example of a general-purpose network computing environment into which various aspects of the present invention may be incorporated.

### DETAILED DESCRIPTION

Various aspects of the technology described herein are generally directed towards an aggregate (e.g., personal) computing system, in which various computing machines are aggregated into what is generally a unified entity, instead of operating as separate parts. For example, a user can couple two or more computing machines into an aggregated computer system, and thereafter control one machine's connected pointing device (e.g., mouse) and/or keyboard for use on another machine. From the user's perspective, the control and device usage is a seamless and relatively easy computing experience.

While the technology is described with various examples and architectures, it is understood that the architectures and components thereof are only examples of possible implementations. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing in general.

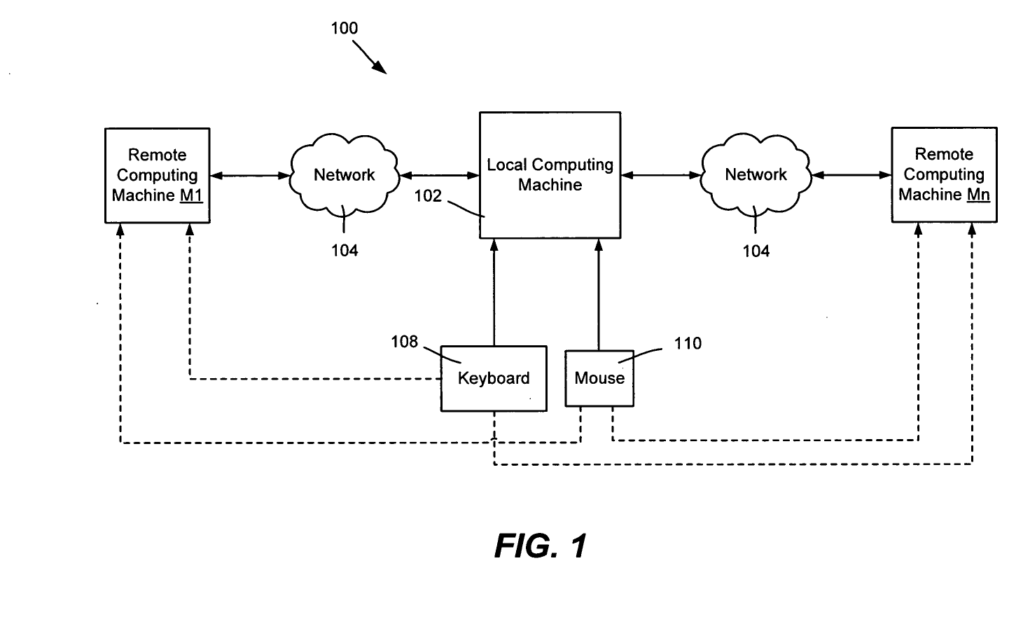

Turning to FIG. 1, there is shown a general block diagram in which an example aggregate computer system 100 is comprised of a local computing machine 102 coupled via a network 104 to remote computing machines M1-Mn. While one local computing machine 102 and two such remote computing machines M1-Mn are exemplified in FIG. 1, it is understood that as few as one such remote computing machine up to any practical number may be present in a given environment. Moreover, although one machine is described as being “local” with respect to other remote machines, in general, any machine can act as the local machine, and thus “local” generally represents the one machine with which the user is (or the user believes to be) physically interacting at a given moment (including wireless interaction).

The network 104 may be any suitable wired or wireless network, or a combination of wired and wireless communication means, such as Ethernet and/or WiFi, and so forth. Remote computing machines and/or their hardware devices also may be coupled by other means, such as USB (Universal Serial Bus), serial, parallel, infrared, FireWire, Bluetooth® and the like; note that while some of these may not necessarily be considered “network” connections in a conventional sense, for purposes of simplicity in this description, any such connections can be considered as networked via the network 104.

Human interface devices such as a keyboard 108 and a mouse (or other pointing device) 110 serve as basic input devices for traditional computers, e.g., in general, a personal computer system includes at least one mouse and one keyboard. Some computer users may have two or more such computer systems in their home or office, each having their own mouse and keyboard. As will be understood, described herein a technology including various mechanisms that enable a computer user to use one computer's human interface device or devices (e.g., mouse and/or keyboard) to control other computers, so that, for example, as little as one mouse and/or keyboard is needed to control multiple computers.

In one example implementation, the remote mouse and keyboard system described herein operates in a peer-to-peer-based software environment. As described in the aforementioned U.S. patent application entitled “Aggregate Personal Computer System,” various computers that make up the aggregate computer system automatically detect other peers (computers) in a local network. Once discovered, a remote computer may be selected to be remotely controlled. If the control request is authorized by the remote computer, the output of the local mouse or keyboard is redirected to the remote computer thereby controlling that computer; note that when a mouse or keyboard is used to control a remote computer, its output is not sent to the local computer, until the remote control operating state is canceled by the user. Further note that mouse and/or keyboard data can be separate, or alternatively handled together; for example a user may select that only mouse data, or only keyboard data can be sent to remotely control another computing machine, or the user can select that both mouse and keyboard data be sent to remotely control the other computing machine. Thus, while the examples herein are directed towards keyboard and pointing device (e.g., mouse) data, it is understood that any human interface device may be used to control a remote computing machine.

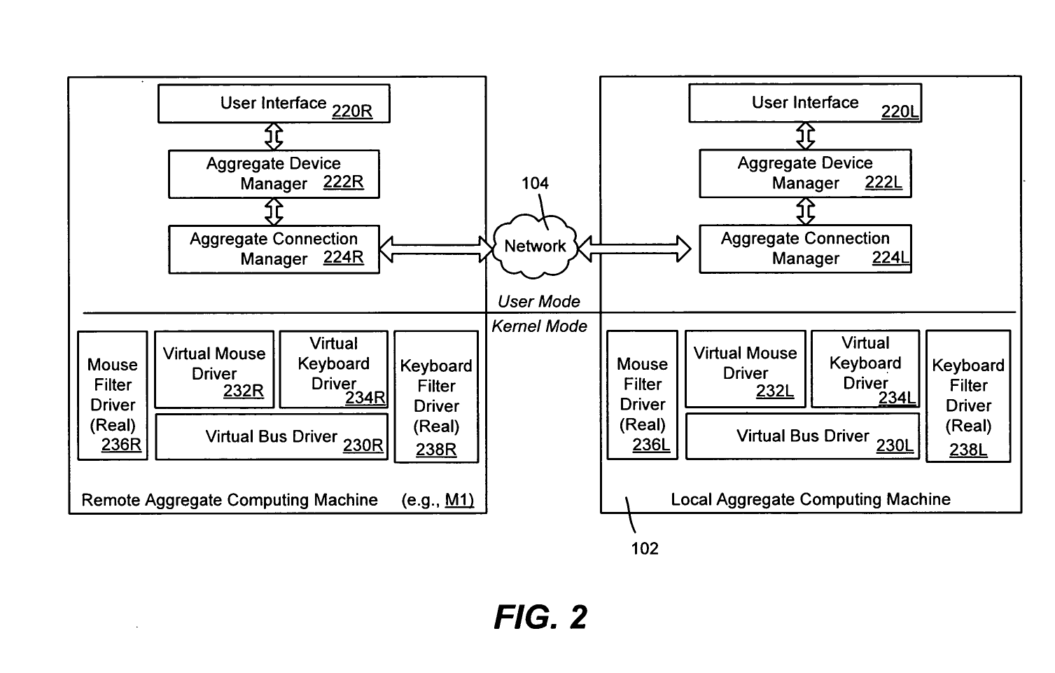

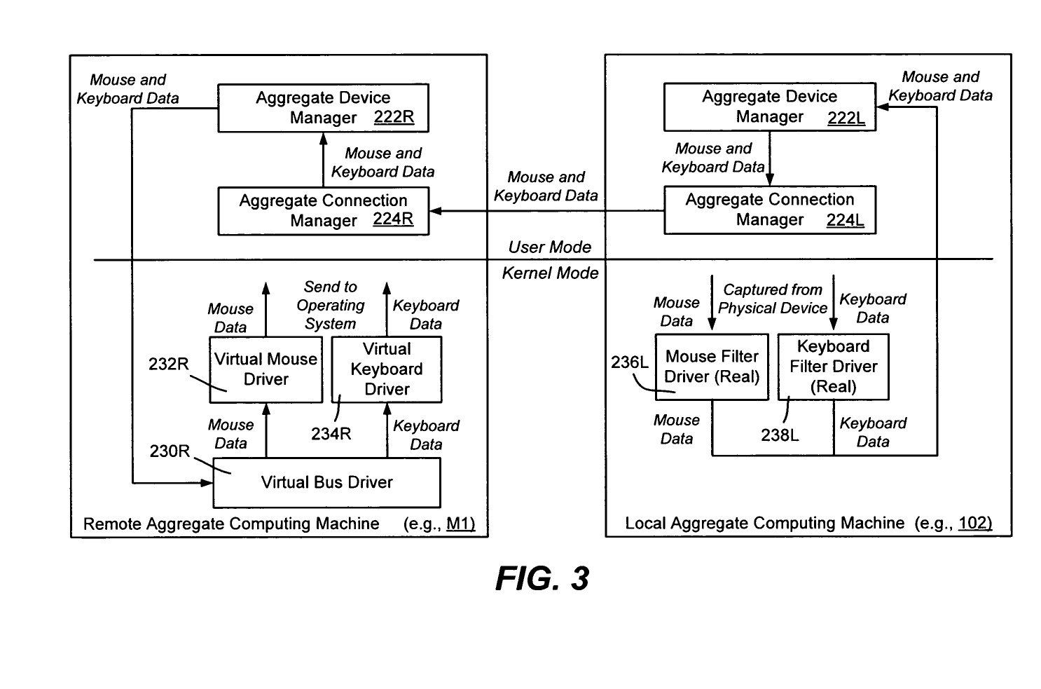

As represented in FIG. 2, each computing machine includes a user mode and kernel mode with various components in each. Note that in FIGS. 2 and 3, the “L” in each component label represents a local component, and the “R” in each component label represents a remote counterpart component corresponding to that local component; however the “L” and “R” labels are ordinarily omitted in the following description, except where otherwise noted.

The user mode includes a user interface 220, an aggregate (personal computer) device manager 222, and an aggregate connection manager 224. The kernel mode includes a virtual bus driver 230, a virtual mouse (filter) driver 232 and a virtual keyboard (filter) driver 234. The kernel mode also includes a real mouse (filter) driver 236 and a real keyboard (filter) driver 238.

The user interface 220 provides interaction with users, and for example is in charge of displaying remote computers and their devices' information, and acquiring requests by a user to control a remote device or devices. The aggregate device manager 222 manages the available networked computers and devices, and in general acts as an intermediary between the user interface 220 and the connection manager 224. Additional details about an example user interface, aggregate device manager and connection manager are described in the aforementioned U.S. patent application entitled “Aggregate Personal Computer System,”

In general, the aggregate device manager 222 sends information about the computers and their devices to the user interface, acquires users' control requests from the user interface 220, and transfers them to the connection manager 224. Management operations may include discovering and registering of physical devices, local and remote device management, device Plug-and-Play management, device connection and data transfer between aggregate computing machines. Management also includes local device broadcasting, connection maintenance between aggregate computing machines, and management of filter driver controllers and virtual driver controllers.

Connectivity to each other aggregate computing machine in the aggregate computer system 100 is provided by the aggregate connection manager 224. For example, the connection manager is in charge of network communication between computers, comprising data transferred between computers including computer and device information, mouse and keyboard data, and control information. In one implementation, the aggregate connection manager 224 allows various types of connections (e.g., via connection modules) between the aggregate computing machines 102 and M1-Mn, to generally provide the same communication experience to other components, and in particular to the aggregate device manager 222, regardless of the actual connection type, e.g., via Ethernet, USB, Bluetooth, Wi-Fi, IrDA or any other connection mechanism.

In one example, the aggregate connection manager 224 further provides various functionalities for the aggregate device manager 222. Such functionalities include registering and management of connection modules, establishing and terminating of communication channels, broadcasting information for the local computing machine, discovering communication channels of the other remote aggregate computing machines, and connection and data transfer between communication channels.

In one example implementation, the aggregate connection manager 224 provides APIs for applications to communicate over a virtual named channel based on a client/server mode. Similar to named pipes, a virtual named channel is a named, duplex channel for communication between a channel server and one or more channel clients. The instances of a virtual named channel share the same pipe name, but each instance has its own buffers and handles, and provides a separate conduit for client-server communication. In general, the aggregate connection manager 224 hides the details of the underlying network including network type and network address, and provides a simple unified APIs for applications to communicate with each other, in an efficient way with respect to establishing a data connection, transferring data and checking network exceptions. For example, one aggregate connection manager includes channel management and host management in which each virtual named channel can be viewed as a server managed by a virtual named channel service. Channel instance management manages the mapping relationship between created virtual named channel instances and the underlying sockets. Data transferring controls how data is receive or sent over the virtual named channel, and exceptions and errors on virtual named channels are handled by an exception handling component. Host management hides the details of discovering available hosts in the network environment via host discovery, and resolves a network address of a host by host address resolving.

As represented in FIG. 3, the device manager 222 acts as an intermediary between the connection manager 224 and the kernel mode subsystems, e.g., the real and virtual mouse and keyboard drivers. For example, when a local mouse or keyboard is controlling a remote computer (e.g., M1), the device manager 222L receives mouse and/or keyboard data from the mouse filter driver 236L and/or keyboard filter driver 238L and transfers the data to the connection manager 224L. Thus, when another computing machine's (e.g., the machine 102) mouse or keyboard 236L or 238L is controlling the computer M1, the controlled computer's device manager 222R receives the mouse or keyboard data from the connection manager 224R and transfers the data to its virtual mouse driver 232R or keyboard driver 234R.

More particularly, in FIG. 3 the virtual mouse driver 232R and virtual keyboard driver 234R receive mouse and keyboard data from the virtual bus driver 230R. In one example system, this is implemented by invoking virtual mouse and keyboard driver data-receiving callbacks, which were registered with the virtual bus driver 230 when the virtual mouse and keyboard drivers 232 and 234 initialized. In one example implementation, this is done by sending an interrupt request packet (IRP) to the virtual bus driver 230R.

Note that the virtual bus driver 230 is provided for a virtual bus on which the virtual device drivers 232 and 234 are installed, whereby the aggregate device manager 222 communicates with virtual devices through the virtual bus driver 230. The virtual bus driver 230 controls data transfer between virtual devices and the aggregate device manager 222, controls the installation of virtual device drivers, controls virtual device registration to the operating system, and controls un-installation of the virtual devices from the operating system. The virtual bus driver 230 provides virtual device management and Plug-and-Play features of the aggregate computer system 100.

In general, the virtual mouse driver 232 and virtual keyboard driver 234 act as virtual devices. More particularly, when a local computer's mouse or keyboard is used to control a remote computer, a new instance of a virtual mouse or keyboard driver is plugged to the remote computer's virtual bus driver 230. As one result, for example, an additional mouse and/or keyboard appear in the remote computer's device manager. To this end, the virtual bus driver 230 communicates with the operating system and manages virtual devices. Each virtual driver 232 or 234 controls its respective virtual device and presents the virtual devices to the operating system as real devices, where, as set forth above.

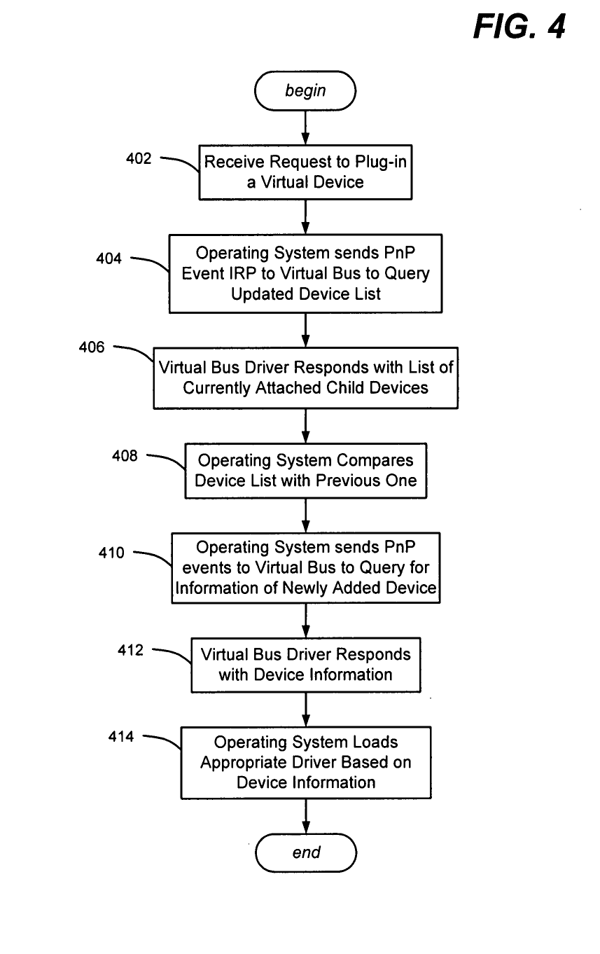

Because a virtual bus does not control hardware, plug and play is simulated to make the virtual devices usable. To this end, a series of steps are performed to prepare a virtual device for use. As represented in FIG. 4, example steps for plugging a new device into the virtual bus include notifying the bus driver 230 to plug in a new device, e.g., via a user's request through an application (step 402). In response, the virtual bus driver 230 creates a child PDO (Physical Device Object) for the virtual device, and keeps it in an internal list of children (child list), and reports a device relation change to the operating system.

At step 404, the operating system (e.g., a PnP manager component thereof) sends a PnP event IRP to the virtual bus to query the updated device list. The virtual bus driver 230 responds with an array of the currently attached child devices, as represented by step 406. By comparing (step 408) the device list with a previous one, the operating system recognizes that a new device has been connected, whereby at step 410 the operating system sends a series of PnP events to the virtual bus to query for detailed device information of the newly added device.

The virtual bus driver 230 responds with the device information, as represented by step 412. According to the device information, at step 414 the operating system loads the appropriate virtual driver (e.g., 232 or 234) for the newly added device. At this time, the new device is ready for use, whereby the operating system is able to send data to or receive data from the virtual device like other local devices.

When a virtual device is removed, the operating system sends a series of PnP events to the virtual bus driver 230 and the device driver (e.g., 232 or 234). The virtual bus driver 230 responds by removing the PDO of the corresponding child device from the internal child list, and destroys the PDO.

As can be seen, sending PnP events is one primary way for an operating system to communicate with the virtual bus driver 230 and query information about enumerated devices. The bus driver 230 processes some of these events, and responds with requested data.

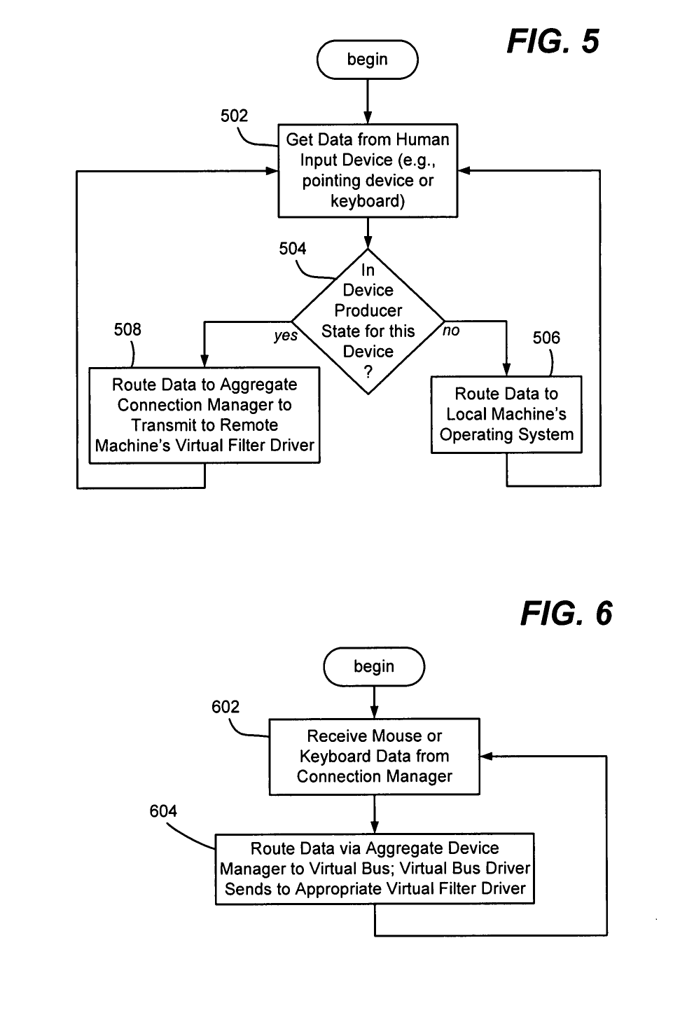

FIG. 5 provides a summary of the operations of the aggregate device manager 222 with respect to processing human interface device (e.g., keyboard and mouse) events that are generated by a respective real local device (e.g., the keyboard 108 and/or mouse 110). As is known, a main task of a mouse filter driver 236 or keyboard filter driver 238 is to capture mouse or keyboard data, respectively, from its corresponding physical device; note that a physical device includes any device that is physically coupled to a computer system, which includes wired or wireless couplings). When a local mouse 110 or keyboard 108 is used to control a remote computer (e.g., M1), the real mouse driver 236 or real keyboard filter driver 238 record the mouse or keyboard data, respectively, and buffers the data. Note that in an aggregate computing environment, the real mouse driver 236 or real keyboard filter driver 238 buffers the data for the aggregate device manager, not the operating system.

From the buffer, the aggregate device manager 222 gets the data, as represented in FIG. 5 via step 502. Step 504 evaluates whether the device that provided the data is currently in a state in which it is a device producer for a remote machine. If not, at step 504 the aggregate device manager 222 routes the data to the local machine's operating system, whereby the local machine processes the data as would a conventional personal computer system.

If instead at step 504 the device that provided the data is currently in a state in which it is a device producer for a remote machine, the data is instead routed to the aggregate connection manager, which transfers it to the remote machine, where it ultimately will be provided to the appropriate virtual filter driver on that machine, thereby controlling the remote machine. Note that as used herein, the data may be routed in any format, such as compressed and/or encrypted, but is nevertheless received and converted to equivalent data and thus any such intermediate data processing is not considered herein as relevant.

FIG. 6 represents example steps to handle such received keyboard or mouse data received at a machine's connection manager (step 602). As described above, the connection manager provides the data to the receiving machine's aggregate device manager, which then provides it to the virtual bus, whereby the virtual bus driver sends the data to the corresponding virtual filter driver (step 604).

### Exemplary Operating Environment

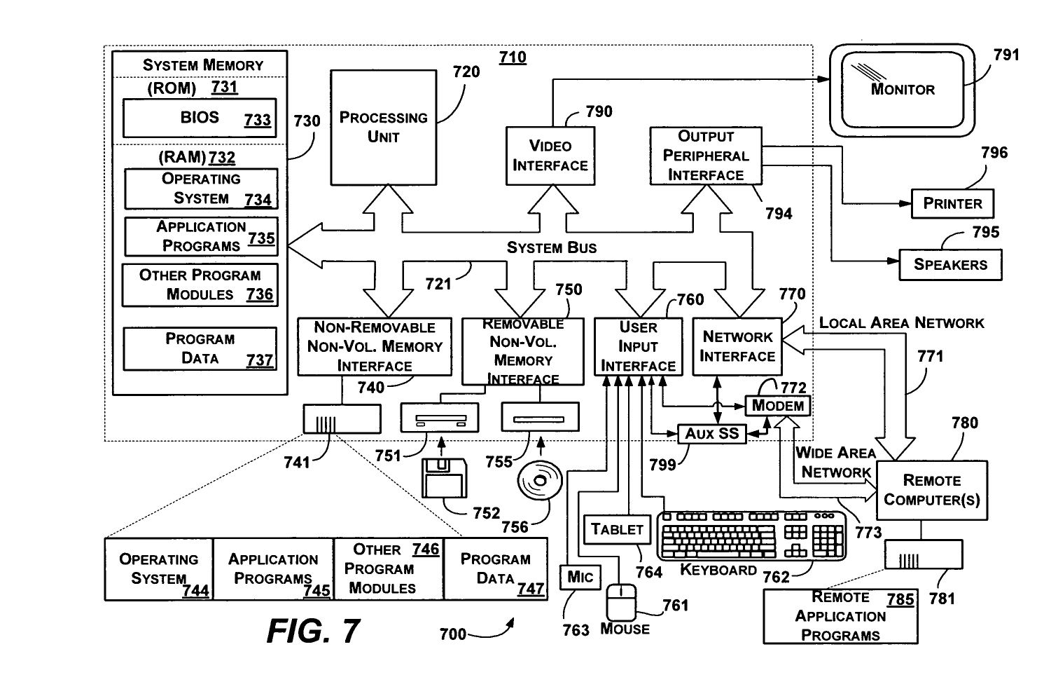

FIG. 7 illustrates an example of a suitable computing system environment 700 on which an aggregate computer system (FIGS. 1-3) may be implemented. The computing system environment 700 is only one example of a suitable computing environment and is not intended to suggest any limitation as to the scope of use or functionality of the invention. Neither should the computing environment 700 be interpreted as having any dependency or requirement relating to any one or combination of components illustrated in the exemplary operating environment 700.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 7, an exemplary system for implementing various aspects of the invention may include a general purpose computing device in the form of a computer 710. Components of the computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 710 typically includes a variety of computer-readable media. Computer-readable media can be any available media that can be accessed by the computer 710 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 710. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736 and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media, described above and illustrated in FIG. 7, provide storage of computer-readable instructions, data structures, program modules and other data for the computer 710. In FIG. 7, for example, hard disk drive 741 is illustrated as storing operating system 744, application programs 745, other program modules 746 and program data 747. Note that these components can either be the same as or different from operating system 734, application programs 735, other program modules 736, and program data 737. Operating system 744, application programs 745, other program modules 746, and program data 747 are given different numbers herein to illustrate that, at a minimum, they are different copies. A user may enter commands and information into the computer 710 through input devices such as a tablet, or electronic digitizer, 764, a microphone 763, a keyboard 762 and pointing device 761, commonly referred to as mouse, trackball or touch pad. Other input devices not shown in FIG. 7 may include a joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. The monitor 791 may also be integrated with a touch-screen panel or the like. Note that the monitor and/or touch screen panel can be physically coupled to a housing in which the computing device 710 is incorporated, such as in a tablet-type personal computer. In addition, computers such as the computing device 710 may also include other peripheral output devices such as speakers 795 and printer 796, which may be connected through an output peripheral interface 794 or the like.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include one or more local area networks (LAN) 771 and one or more wide area networks (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760 or other appropriate mechanism. A wireless networking component 774 such as comprising an interface and antenna may be coupled through a suitable device such as an access point or peer computer to a WAN or LAN. In a networked environment, program modules depicted relative to the computer 710, or portions thereof, may be stored in the remote memory storage device. By way of example, and not limitation, FIG. 7 illustrates remote application programs 785 as residing on memory device 781. It may be appreciated that the network connections shown are exemplary and other means of establishing a communications link between the computers may be used.

An auxiliary subsystem 799 (e.g., for auxiliary display of content) may be connected via the user interface 760 to allow data such as program content, system status and event notifications to be provided to the user, even if the main portions of the computer system are in a low power state. The auxiliary subsystem 799 may be connected to the modem 772 and/or network interface 770 to allow communication between these systems while the main processing unit 720 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising:
obtaining human interface device data from a corresponding human interface device physically coupled by a wired or wireless connection to a first computing machine;
routing the human interface device data to a second computing machine coupled to the first computing machine via a remote communications means;
receiving the human interface device data at the second computing machine; and
providing the human interface device data to a corresponding virtual human interface device driver of the second computing machine, to control operation of the second computing machine from the human interface device physically coupled to the first computing machine.

2. The method of claim 1 wherein obtaining the human interface device data comprises accessing a corresponding storage into which a real device driver for that human interface device has buffered the human interface device data.

3. The method of claim 1 wherein routing the human interface device data to the second computing machine comprises providing the data to an aggregate connection manager of the first machine, and communicating corresponding information to an aggregate connection manager of the second machine.

4. The method of claim 1 wherein providing the human interface device data to the corresponding virtual human interface device driver comprises providing the data to a virtual bus driver of the second computing machine with which the virtual human interface device driver has registered.

5. The method of claim 1 further comprising, receiving device information at the second computing machine in response to a query for information of the human interface device; plugging in a virtual human interface device by loading the virtual human interface device driver in the second computing machine based on the device information.

6. The method of claim 5 further comprising, at the second computing machine, querying for the information of the human interface device by sending events to a virtual bus.

7. The method of claim 5 further comprising, at the second computing machine, querying for an updated device list, receiving the updated device list, and comparing the updated device list with a previous device list to determine which device to query for the information.

8. The method of claim 7 wherein the second computing machine queries for the information of the device and for the updated device list by sending plug-and-play events.

9. In a computing environment, a system comprising:
a first computing machine configured as a human interface device producer that generates human interface device data from a corresponding human interface device physically coupled by a wired or wireless connection to the first computing machine; and
a second computing machine that is not physically coupled to the human interface device, the second computing machine configured as a human interface device consumer that receives the human interface device data from the first computing machine over a network connection, to control operation of the second computing machine via a virtual driver on the second computing machine that corresponds to the human interface device.

10. The system of claim 9 further comprising a real human interface device driver that buffers the human interface device data for an aggregate device manager, the aggregate device manager determining that the first computing machine is in a device producer state with respect to that human interface device, and as a result, sends the human interface device data to the second computing machine.

11. The system of claim 10 wherein the second machine includes a virtual bus driver for simulating physical connection of the human interface device to the second machine via a bus.

12. The system of claim 10 wherein the aggregate device manager sends the human interface device data to the second computing machine via a connection manager of the first computing machine that is coupled to a connection manager of the second computing machine via the network connection.

13. The system of claim 12 wherein the connection manager of the second computing machine routes the human interface device data to the virtual driver via an aggregate device manager of the second machine that is coupled to a virtual bus driver of the second machine.

14. The system of claim 10 wherein the human interface device comprises a mouse or a keyboard.

15. The system of claim 10 wherein the network connection comprises an Ethernet connection, a WiFi connection, a Universal Serial Bus connection, a serial connection, a parallel connection, an infrared connection, a FireWire connection or a Bluetooth® connection.

16. At least one computer-readable medium having computer-executable instructions, which when executed perform steps comprising, controlling a second computing machine via a human interface device that is physically coupled to a first computing machine via a wired or wireless connection, including by transmitting human interface device data over a communication means to the second computing machine, receiving the human interface device data at the second computing machine, and simulating a physical connection of the human interface device to the second computing machine by providing the human interface device data to a virtual driver that is loaded on the second computing machine.

17. The computer-readable medium of claim 16 having further computer-executable instructions, comprising, at the first computing machine, obtaining the interface device data from a real human interface device driver, and transmitting the human interface device data upon determining that the human interface device corresponds to a device producer operating state.

18. The computer-readable medium of claim 16 having further computer-executable instructions, comprising, at the first computing machine, receiving information indicating that the human interface device no longer corresponds to a device producer operating state, and in response, sending the human interface device data to an operating system of the first computing machine.

19. The computer-readable medium of claim 16 having further computer-executable instructions, comprising, at the second computing machine, querying for information of the human interface device by sending events to a virtual bus, receiving the information in response to the query, and loading the virtual human interface device driver in based on the information.

20. The computer-readable medium of claim 16 wherein simulating the physical connection of the human interface device to the second computing machine includes coupling the virtual driver to a virtual bus driver that is loaded on the second computing machine.
